(19) United States
(12) Patent Application Publication
(10) Pub. No.: US 2012/0299433 A1
(43) Pub. Date: Nov. 29, 2012

(54) STATOR OF A PERMANENTLY EXCITED ROTATING ELECTRIC MACHINE

(75) Inventor: Axel Möhle, Berlin (DE)

(73) Assignee: Siemens Aktiengesellschaft, München (DE)

(21) Appl. No.: 13/576,859

(22) PCT Filed: Dec. 30, 2010
(86) PCT No.: PCT/EP2010/070929

§ 371 Date: Aug. 2, 2012

(30) Foreign Application Priority Data
Feb. 5, 2010 (DE) 10 2010 001 619.5

(51) Int. Cl. H02K 1/16

(52) U.S. Cl. 310/216.072

(57) ABSTRACT

The invention relates to a stator of a permanently excited rotating electric machine having first and second coil groups arranged directly sequentially in the circumferential direction, wherein a first central tooth having a first central tooth width MB is disposed at the center of the first coil group, wherein a first boundary tooth having a first boundary tooth width RB is disposed between the first and the second coil groups, wherein the first boundary tooth width RB is substantially RB=a*ZB and the first central tooth width MB is substantially MB=(2a)*ZB, wherein the factor a is greater than 0 and less than 1. The detent moments and/or oscillating moments occurring in a permanently excited rotating electric machine can thereby be reduced.

The invention relates to a stator of a permanently excited rotating electric machine.

With a permanently excited rotating electric machine, such as for instance a permanently excited generator or a permanently excited electric motor, the detent moments are in particular a critical design variable during idling of the electric machine. The amplitude of the detent moments must be kept to a minimum here. Furthermore, the oscillating moments which occur under load must also be kept to a minimum.

Particularly with directly driven, permanently excited wind power generators, the detent moments, which occur during idling, and the oscillating moments, which occur during operation of the wind power generator, are to be kept to a minimum.

The following methods are essentially used nowadays to minimize the oscillating moments:
Skewing of the permanent magnets disposed in the rotor of the electric machine,
Skewing of the electrical conductors in the stator of the electric machine,
Displacement of the permanent magnets of the rotor from the pole axis.

The afore-cited known methods are however complicated in terms of manufacture.

Particularly with large electric machines, the stator is usually equipped with so-called double layer windings, in rare cases also with single layer windings. In order in this way to be able to realize coils with the same width, the width of the teeth and grooves is usually realized, particularly in two-layer windings, such that a uniform groove pitch width results across the circumference of the stator, wherein all teeth and grooves have a uniform width. With single layer windings having three tiers or with barrel coils, a so-called double pole division is in contrast realized by the arrangement of the coils of a coil group per coil group in each instance, so that a so-called terminal pair results for each coil group. A region at the circumference of the stator, in which no coils are disposed, is located downstream of each coil group. This feature of the arrangement can be used to vary the groove pitch width across the circumference of the stator without in this way the width of the coils having to be different. This can be used to reduce developing detent and oscillating moments and to improve the shape of the field curve (winding factor).

The object of the invention is to reduce detent and/or oscillating moments which occur with a permanently excited rotating electric machine.

This object is achieved by a stator of a permanently excited rotating electric machine, wherein the stator comprises several teeth and grooves extending in the axial direction of the stator, wherein coil groups are disposed along the circumference of the stator, wherein the coil groups each have at least three coils which are disposed in grooves disposed directly consecutively to one another in the circumferential direction, wherein all grooves have a uniform groove width NB, wherein the teeth, which are not disposed in the center of a coil group and not between two coil groups disposed so that they directly follow one another in the circumferential direction of the stator have a uniform tooth width ZB, wherein a first central tooth, which has a first central tooth width MB, is disposed in the center of a first coil group, wherein the stator has a second coil group, wherein the first and the second coil group are disposed so that they directly follow one another in the circumferential direction, wherein a first boundary tooth, which has a first boundary tooth width RB, is disposed between the first and the second coil group, wherein the first boundary tooth width RB is essentially

RB=a·ZB

and the first central tooth width MB is essentially

MB=(2−a)·ZB,

wherein the factor a is greater than 0 and less than 1.

Advantageous embodiments of the invention result from the dependent claims.

It has proven advantageous if the factor a is greater than 0 and a maximum of 0.35. If the factor a is greater than zero and a maximum of 0.35, the detent and/or oscillating moments are reduced particularly significantly.

Furthermore, it has proven advantageous if the boundary tooth widths and the central tooth widths in the remaining coil groups are embodied similarly to the first coil group, wherein the factor a is identical in all coil groups or the factor a is different in at least two coil groups. If the factor a is identical in all coil groups, a very symmetrical overall arrangement results and the detent and/or oscillating moments are reduced particularly significantly. If the factor a is non-uniform, the stator can be manufactured particularly easily.

The permanently excited rotating electric machine may be embodied in this way for instance as a generator or electric motor, wherein the generator is embodied in particular as a wind power generator and in particular as a directly driven (the wind wheel is connected directly to the wind power generator without intermediate gearing) wind power generator.

An exemplary embodiment of the invention is shown in the drawing and explained in more detail below, in which:

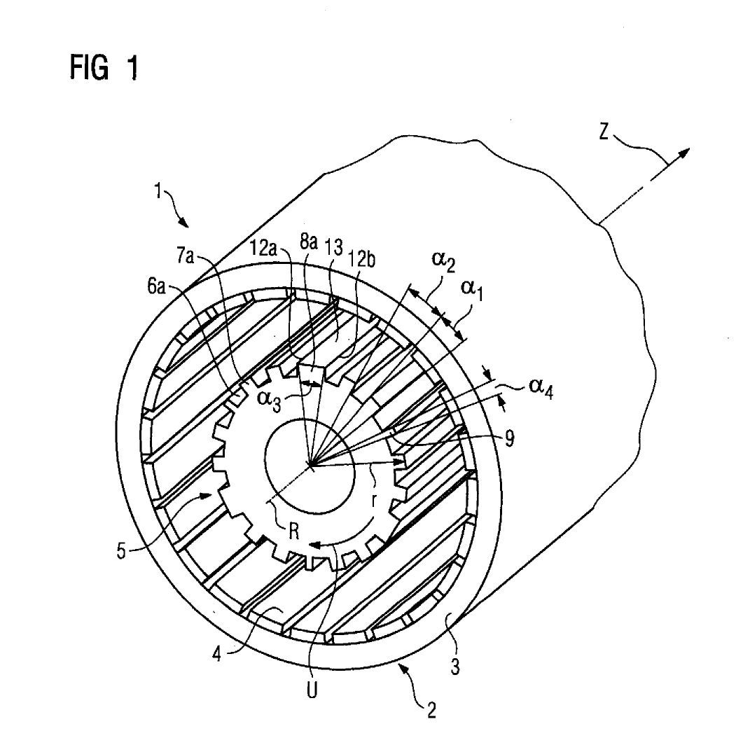

FIG. 1 shows a schematic view of an inventive permanently excited rotating electric machine; and

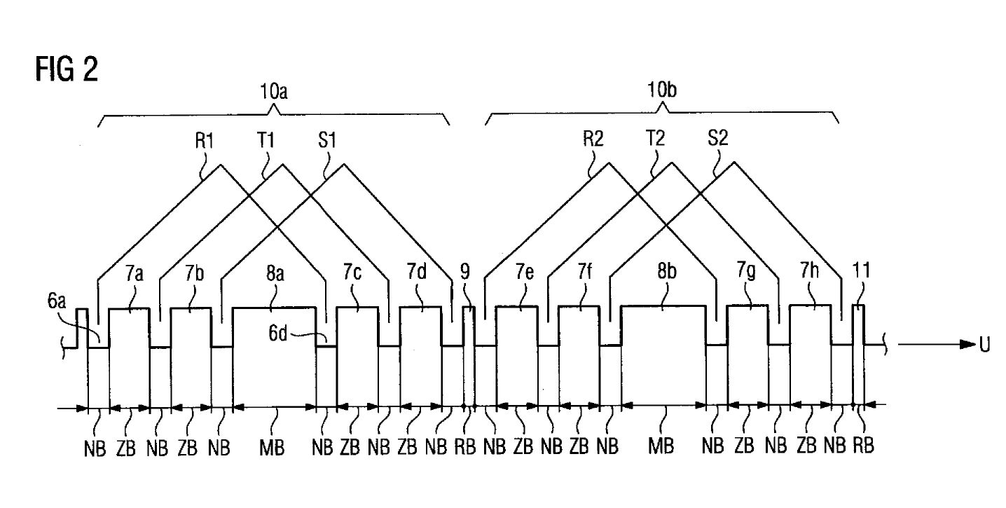

FIG. 2 shows a schematic detailed view of a cutout of an inventive stator of the machine.

FIG. 1 shows an inventive permanently excited rotating electric machine 1 in the form of a schematic perspective representation. The machine 1 is in this way embodied within the scope of the exemplary embodiment as a generator and in particular as a wind power generator. It should be noted at this point that for the sake of clarity, only the elements of the machine 1 which are essential to the understanding of the invention are shown in FIG. 1.

The machine 1 has a rotor 2, which is disposed so as to be rotatable about an axis of rotation R of the machine 1. In this way the rotor 2 includes all elements of the machine 1 which are disposed so as to be rotatable about the rotor axis R. The rotor 2 has a rotor yoke 3, on which permanent magnets are disposed, wherein for the sake of clarity, only a permanent magnet 4 is provided with a reference character in FIG. 1. During operation of the machine 1, the rotor 2 rotates within the scope of the exemplary embodiment about a stator 5 disposed centrally in the machine 1 and at rest compared with the surroundings of the machine 1. Since the rotor 2 is disposed around the stator 5, such a machine, in technical terms, is also referred to as an external rotor. Since the rotor 1 has permanent magnets, which permanently generate a magnetic field for operating the machine 1, such a machine, in technical terms, is also referred to as a permanently excited or permanent-magnet excited machine. Since the machine 1 has a rotor 2 rotating about an axis of rotation R during operation of the machine 1, such a machine is also referred to as rotating electric machine.

The stator 5 has several teeth and grooves running in the axial direction Z, wherein for the sake of clarity, only the teeth 7a, 8a and 9 and the groove 6a are provided with reference characters in FIG. 1. The stator consists here within the scope of the exemplary embodiment of metal sheets disposed one behind the other in the axial direction Z. The individual metal sheets are as a rule provided here with an electrical insulating layer, such as for instance a lacquered coating.

The teeth and grooves of the segments develop on account of a corresponding embodiment of the form of the metal sheets. The electric coils of the stator extend around the teeth in the grooves, wherein for the sake of clarity and as they are irrelevant to the understanding of the invention, the coils are not shown.

With commercially available permanently excited rotating electric machines, the widths of the individual teeth of the stator 5 are all identical here. In accordance with the invention, detent and oscillating moments developing during operation of the machine 1 are, on account of a targeted enlargement and reduction in the width of specific teeth compared with the remaining teeth of the stator, reduced.

It should be noted again at this point that FIG. 1 is a schematic representation, in which for instance the width, number and dimensions of the teeth, grooves and permanent magnets, as well as the size of the air gap disposed between the stator and rotor do not correspond with reality.

FIG. 2 shows a cutout of the stator 5 in the form of a schematic sectional view. For the sake of clarity, the cutout of the stator 5 is schematically shown here not in the shape of an arc, as in reality, but is instead shown rolled out on a plane.

Coil groups are disposed along the circumference of the stator 5, wherein the coil groups each have at least three coils. FIG. 2 shows a first coil group 10a, which consists of the three coils R1, T1 and S1, and a second coil group 10b, which consists of the three coils R2, T2, and S2. The coils are only shown symbolically here. The second coil group 10b is disposed directly downstream of the first coil group 10a in the circumferential direction U of the stator. For the sake of clarity, only the grooves 6a and 6d are provided with a reference character in FIG. 2, wherein all grooves of the stator have the same groove width NB, i.e. a uniform groove width NB.

Within the scope of the exemplary embodiment, as already mentioned, the first coil group 10a has the coils R1, T1 and S1 and the second coil group 10b the coils R2, T2 and S2. The coil R1 extends here, as indicated by the symbol of coil R1, in the grooves 6a and 6d and therefore surrounds the teeth 7a, 7b and 8a. Accordingly, the remaining coils extend in the grooves assigned to the respective coils, such as shown by the symbols of the coils. The phase current R flows through the coils R1 and R2, the phase current T flows through the coils T1 and T2 and the phase current S flows through the coils S1 and S2. The coil groups are disposed here along the circumference of the stator. As already mentioned, within the scope of the exemplary embodiment, the coils groups in this way comprise three coils respectively. This need not necessarily be so, instead a coil group can also comprise more than three coils. The coil groups can also comprise six coils respectively for instance, wherein in this case the phase current R flows through the first two coils that directly follow one another in the circumferential direction U, the phase current T flows through the next two coils that directly follow one another in the circumferential direction U and the phase current S flows through the next two coils that directly follow one another in the circumferential direction U so that a three-phase system results again overall.

The teeth 7a, 7b, 8a, 7c, 7d and the tooth 9 are assigned to the first coil group 10a. The teeth 7e, 7f, 8b, 7g, 7b and 11 are assigned to the second coil group 10b. The teeth which are disposed in the center of the coil groups are subsequently referred to as central teeth and the teeth which are disposed between two coil groups which directly follow one another in the circumferential direction U are subsequently referred to as boundary teeth. The first central tooth 8a is disposed in the center of the first coil group 10a and the second central tooth 8b is disposed in the center of the second coil group 10b. The first boundary tooth 9 is disposed between the first coil group 10a and the second coil group 10b. The second coil group 10b is disposed in the circumferential direction U of the stator directly consecutively downstream of the first coil group 10.

The second boundary tooth 11 is disposed between the second coil group 10b and a third coil group which is not further shown in FIG. 2. The teeth which are not disposed in the center of a coil group and not between two coil groups disposed so that the directly follow one another in the circumferential direction of the stator all have the same tooth width ZB, i.e. a uniform tooth width ZB. Within the scope of the exemplary embodiment, these are the teeth 7a, 7b, 7c, 7d, 7e, 7f, 7g and 7h. The teeth 7a, 7b, 7c, 7d, 7e, 7f, 7g and 7h have a uniform tooth width ZB. As already mentioned, all grooves have the same groove width NB, i.e. a uniform groove width NB. The first central tooth 8a has a first central tooth width MB and the first boundary tooth 9 has a first boundary tooth width RB.

Within the scope of the exemplary embodiment, the respective central tooth in this case has the same central tooth width MB in all coil groups, i.e. a uniform central tooth width MB. Furthermore, all boundary teeth have the same boundary tooth width RB, i.e. a uniform boundary tooth width RB.

With a commercially available stator of a permanently excited rotating electric machine, all teeth and all grooves have a uniform width. In other words, the so-called groove pitch width NTB, which is the total of the width of the tooth and the width of the groove directly following the tooth, results in the following with a commercially available stator:

$$N T B = \frac{U}{N} = \frac{2 \cdot π \cdot r}{N} \qquad ( 1 )$$

wherein N is the number of grooves, U is the circumference of the stator and r is the radius of the stator.

In accordance with the invention, the groove pitch width is changed in order to reduce the detent and/or oscillating moments, by the width of the tooth, which is disposed between two coil groups disposed so as to directly follow one another in the circumferential direction, being reduced by a factor a and the width of the tooth, which is disposed in the center of the coil group to which the boundary tooth, being enlarged according to the factor a. The first boundary tooth width RB of the first boundary tooth 9 is therefore reduced compared with the tooth width ZB and according to the reduction in size, the first central tooth width MB of the first central tooth 8a is enlarged. The following thus applies to the first boundary tooth width RB

RB=a·ZB (2)

and to the first central tooth width MB:

MB=(2−a)·ZB (3)

wherein the factor a is greater than 0 and less than 1. The tooth width ZB corresponds here to the length of the arc across the angle α₁, the groove width NB corresponds to the length of the arc across the angle α₂, the first central tooth width MB corresponds to the length of the arc across the angle α₃ and the first boundary tooth width RB corresponds to the length of the arc across the angle α₄ (see FIG. 1),

Therefore

$$\begin{matrix}Z B = \frac{2 \cdot π \cdot r \cdot {α}_{1}}{{360}^{0}} & ( 4 ) \\ N B = \frac{2 \cdot π \cdot r \cdot {α}_{2}}{{360}^{0}} & ( 5 ) \\ M B = \frac{2 \cdot π \cdot r \cdot {α}_{3}}{{360}^{0}} & ( 6 ) \\ R B = \frac{2 \cdot π \cdot r \cdot {α}_{4}}{{360}^{0}} & ( 6 )\end{matrix}$$

applies, wherein r is the radius of the stator. The radius r of the stator here goes from the axis of rotation R to the side of the teeth facing the rotor 2 (see FIG. 1). The respective angle is the angle which is covered by the edges of the side of the respectively assigned teeth facing the rotor 2 which extend in the axial direction Z, starting from the axis of rotation R (See FIG. 1). The side of the first central tooth 8a facing the rotor 2 is provided with the reference character 13 in FIG. 1 and the edges of the side 11 of the first central tooth 8a facing the rotor 2 and extending in the axial direction Z are provided with reference characters 12a and 12b in FIG. 1.

The inventive reduction in the width of the boundary tooth and corresponding enlargement of the width of the central tooth does not change the width of the coils. The distance between the coils within a coil group is likewise identical. A symmetrical three-phase current system therefore also results as in the case of a commercially available stator.

The groove width NB is selected here such that the coils fit into the grooves.

If the factor a is greater than zero and a maximum of 0.35, detent and/or oscillating moments are particularly significantly reduced.

Within the scope of the exemplary embodiment and according to the first coil group 10a, the boundary tooth widths and the central tooth widths are embodied in the remaining coil groups, wherein the factor a is identical in all coil groups. The central tooth width of the second central tooth 8b is therefore just as large as the central tooth width of the first central tooth 8a and the boundary tooth width of the second boundary tooth 11 is just as large as the boundary tooth width of the first boundary tooth 9.

Alternatively, the value of factor a can however also be different in the coil groups. Therefore factor a may amount to 0.1 in the first coil group 10a for instance and to 0.2 in the second coil group 10b so that different values result for the widths of the central teeth 8a and 8b and the widths of the boundary teeth 9 and 11.

1-5. (canceled)

6. A stator of a permanently excited rotating electric machine, comprising:
a plurality of teeth and grooves extending in an axial direction of the stator, with all grooves having an identical groove width,
a plurality of coil groups arranged sequentially in a circumferential direction of the stator, each coil group comprising at least three coils disposed sequentially in the circumferential direction in adjacent grooves,
wherein the teeth of each coil group comprise a central tooth disposed at a center of a coil group, with the central tooth of a first coil group having a central tooth width (ZB) and a boundary tooth disposed between the first coil group and a directly adjacent second coil group having a first boundary tooth width (RB),
wherein the teeth of each coil group that are not a central tooth and not a boundary tooth have identical tooth widths (ZB),
wherein the first boundary tooth width RB is substantially
RB=a·ZB
and the first central tooth width MB is substantially
MB=(2−a)·ZB,
wherein a is a factor greater than 0 and less than 1.

7. The stator of claim 6, wherein the factor a is greater than 0 and less than or equal to 0.35.

8. The stator of claim 6, wherein all coil groups of the stator have identical central teeth widths and identical boundary teeth widths.

9. The stator of claim 6, wherein at least two coil groups of the stator have mutually different central teeth widths and mutually different boundary teeth widths.

10. A permanently excited rotating electric machine, wherein the machine is embodied as a generator or an electric motor, the machine comprising:
a rotor, and
a stator, the stator comprising
a plurality of teeth and grooves extending in an axial direction of the stator, with all grooves having an identical groove width,
a plurality of coil groups arranged sequentially in a circumferential direction of the stator, each coil group comprising at least three coils disposed sequentially in the circumferential direction in adjacent grooves,
wherein the teeth of each coil group comprise a central tooth disposed at a center of a coil group, with the central tooth of a first coil group having a central tooth width (ZB) and a boundary tooth disposed between the first coil group and a directly adjacent second coil group having a first boundary tooth width (RB),
wherein the teeth of each coil group that are not a central tooth or a boundary tooth have identical tooth widths (ZB),
wherein the first boundary tooth width RB is substantially
RB=a·ZB
and the first central tooth width MB is substantially
MB=(2−a)·ZB,
wherein a is a factor greater than 0 and less than 1.

11. The permanently excited rotating electric machine of claim 10, wherein the machine is embodied as a wind power generator.
